(19) United States
(12) Patent Application Publication
(10) Pub. No.: US 2016/0062565 A1
(43) Pub. Date: Mar. 3, 2016

(54) Method of Removing External Devices for Computer System and Related Computer System

(71) Applicant: Wistron Corporation, New Taipei City (TW)

(72) Inventor: Lifen REN, New Taipei City (TW)

(21) Appl. No.: 14/623,519

(22) Filed: Feb. 17, 2015

(30) Foreign Application Priority Data
Aug. 29, 2014 (CN) 201410436351.7

(51) Int. Cl. G06F 3/0482; G06F 13/38; G06F 3/0484; G06F 13/42

(52) U.S. Cl. CPC G06F 3/0482; G06F 13/4282; G06F 13/385; G06F 3/04842

(57) ABSTRACT

A method of removing external devices for a computer system includes detecting a plurality of external devices connected to the computer system; displaying a list via a display device when the computer system receives a removal indication signal, wherein the list comprises a plurality of selection fields corresponding to the plurality of external devices and each of the plurality of selection fields corresponds to one of the plurality of external devices, respectively; and determining whether to perform a removal procedure on an external device among the plurality of external devices according to whether a selection field corresponding to the external device among the plurality of selection fields is selected when the computer system receives a removal signal.

### BACKGROUND OF THE INVENTION

1. Field of the Invention

The present invention relates to a method of removing external devices from a computer system and the related computer system, and more particularly, to a method capable of simultaneously removing multiple external devices from a computer system and the related computer system.

2. Description of the Prior Art

In recent years, the universal serial bus (USB) has become the most widely utilized external interface of the computer system. Due to the features of hot-plug and easily installed, the USB interface gradually replaces various conventional external interfaces, and is widely utilized for connections of various types of external devices such as a mouse, keyboard, smart phone, external hard disk drive and flash drive.

After an external device is connected to a computer system via a USB interface, a user should click an icon indicating removal of the external device on the display device (e.g., screen) of the computer system if the user needs to securely remove the external device. The external device(s) currently connected to the computer system may be displayed on the display device. The user then clicks one of the external device(s) and removes it. For example, please refer to FIG. 1A and FIG. 1B, which are schematic diagrams of a conventional method of removing USB external devices from a computer system. FIG. 1A and FIG. 1B respectively illustrate a screen on the display device. When an external device is connected to the computer system via a USB interface, the display device of the computer system may appear an icon 102 related to the USB interface, to show that the USB interface is currently connected to the external device. When the user needs to remove the external device, the user should click the icon 102. The display device then pops up with information of the external devices currently connected to the computer system. As shown in FIG. 1A, the external devices currently connected to the computer system include an external hard disk drive A, a flash drive B and a smart phone C. The external hard disk drive A and the flash drive B are configured with removable disks (H:) and (F:), respectively; and the smart phone C is not configured with any disk letter. The user may click one of the external devices and remove it (e.g., the external hard disk drive A). After receiving the click instruction from the user, the computer system may spend a period of time to remove the external device. The display device may pop up with a message indicating a successful removal when the external device is removed successfully, as shown in FIG. 1B. If the user needs to remove another external device (e.g., the flash drive B or the smart phone C), the user has to repeat the above steps to perform the removal.

The above method of removing external devices does not consume too much time when the computer system is connected to only one external device. However, with the popularity of USB technology, a computer system is always connected to multiple external devices via multiple USB interfaces simultaneously. A USB interface may also be simultaneously connected to multiple external devices via a USB hub. In the condition where a computer system is connected to multiple external devices, if the user needs to remove external devices by using the above method, the user should repeat the above procedure and spend a lot of time to remove all of the external devices. For example, assuming that it costs 2 seconds to remove an external device, if a computer system is connected to 3 external devices, removing all of them requires at least 6 seconds; if a computer system is connected to 5 external devices, removing all of them requires at least 10 seconds. Thus, there is a need for improvement over the prior art.

### SUMMARY OF THE INVENTION

It is therefore an objective of the present invention to provide a method of removing external devices from a computer system and the computer system thereof, wherein the method may display a list for the user to make selection and the user may select external devices desired to be removed via a plurality of selection fields corresponding to a plurality of external devices in the list, in order to simultaneously remove multiple external devices in one removal operation.

The present invention discloses a method of removing external devices for a computer system. The method comprises detecting a plurality of external devices connected to the computer system; displaying a list via a display device when the computer system receives a removal indication signal, wherein the list comprises a plurality of selection fields corresponding to the plurality of external devices and each of the plurality of selection fields corresponds to one of the plurality of external devices, respectively; and determining whether to perform a removal procedure on at least one external device among the plurality of external devices according to whether a selection field corresponding to the external device among the plurality of selection fields is selected when the computer system receives a removal signal.

The present invention further discloses a computer system, which comprises a display device; a mainboard, comprising a plurality of external device connection ports; a processing means; and a storage unit. The storage unit is utilized for storing a program code instructing the processing means to execute the following steps in order to remove external devices: detecting a plurality of external devices connected to the plurality of external device connection ports; displaying a list via the display device when the computer system receives a removal indication signal, wherein the list comprises a plurality of selection fields corresponding to the plurality of external devices and each of the plurality of selection fields corresponds to one of the plurality of external devices, respectively; and determining whether to perform a removal procedure on at least one external device among the plurality of external devices according to whether a selection field corresponding to the external device among the plurality of selection fields is selected when the computer system receives a removal signal.

The present invention further discloses a non-transitory computer-readable medium having a program code executable in a computer system. The program code comprises code for detecting a plurality of external devices connected to the computer system; code for displaying a list via a display device when the computer system receives a removal indication signal, wherein the list comprises a plurality of selection fields corresponding to the plurality of external devices and each of the plurality of selection fields corresponds to one of the plurality of external devices, respectively; and code for determining whether to perform a removal procedure on at least one external device among the plurality of external devices according to whether a selection field corresponding to the external device among the plurality of selection fields is selected when the computer system receives a removal signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A and FIG. 1B are schematic diagrams of a conventional method of removing USB external devices from a computer system.

FIG. 2 is a schematic diagram of removing external devices from a computer system according to an embodiment of the present invention.

FIG. 3 is a schematic diagram of a display device displaying a successful removal of the external device according to an embodiment of the present invention.

FIG. 4 is a schematic diagram of a display device displaying a failed removal of the external device according to an embodiment of the present invention.

FIG. 5 is a schematic diagram of a computer system according to an embodiment of the present invention.

FIG. 6 is a schematic diagram of a USB control circuit according to an embodiment of the present invention.

FIG. 7 is a schematic diagram of an external device removal process according to an embodiment of the present invention.

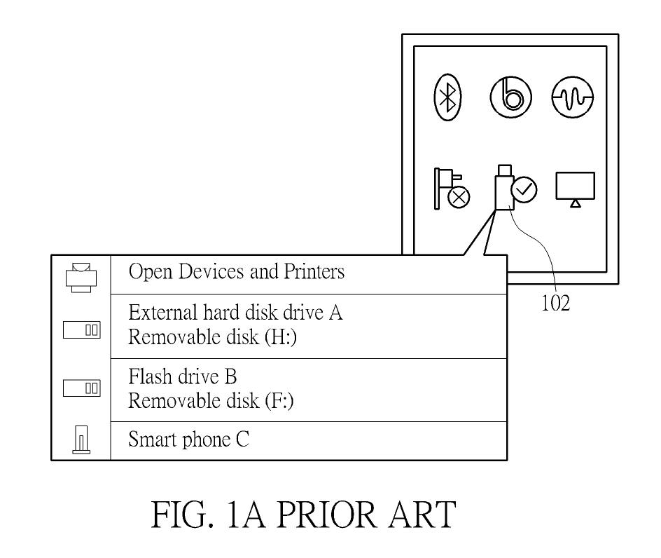

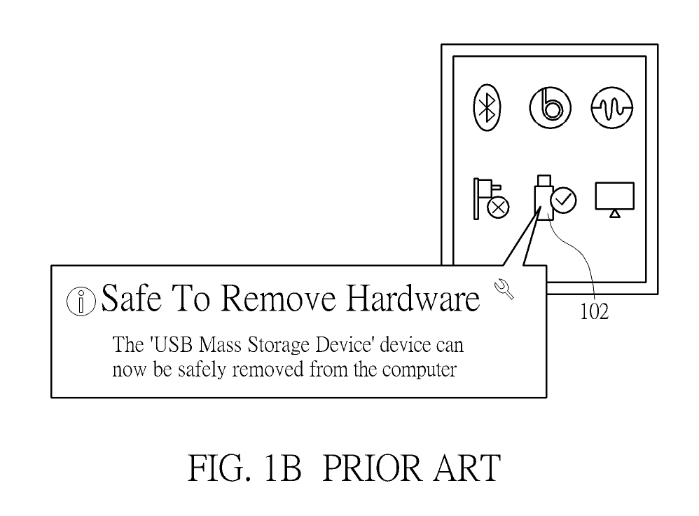

### DETAILED DESCRIPTION

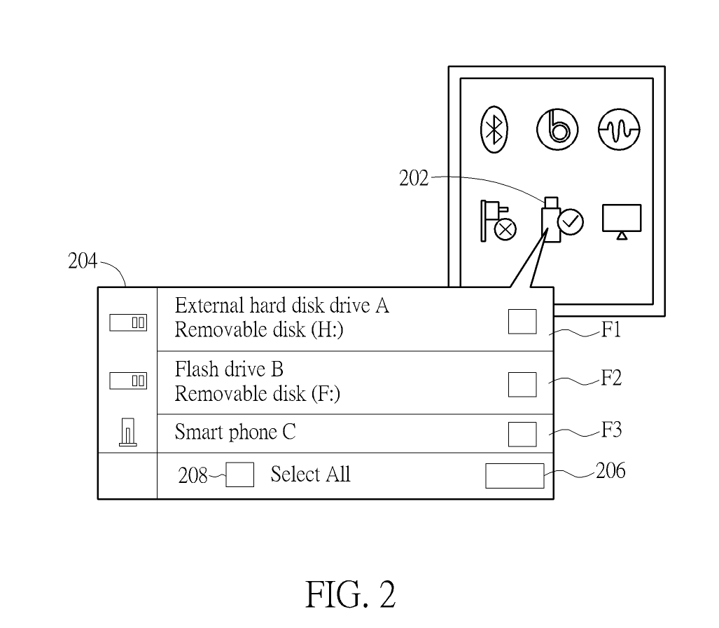

Please refer to FIG. 2, which is a schematic diagram of removing external devices from a computer system according to an embodiment of the present invention. FIG. 2 illustrates a screen on a display device of the computer system. Take a universal serial bus (USB) interface as an example. The computer system may detect a plurality of external devices currently connected to it. When the user clicks an icon 202 related to the USB interface, the computer system may receive a removal indication signal. At this moment, the display device may display a list 204 including a plurality of selection fields, to display the names of the plurality of external devices currently connected to the computer system and their corresponding disk letters, wherein each selection field may correspond to one of the plurality of external devices. As shown in FIG. 2, the list 204 includes three selection fields F1-F3 for displaying the names of the corresponding external devices (i.e., the external hard disk drive A, the flash drive B and the smart phone C) and the corresponding disk letters (i.e., the removable disk (H:) corresponding to the external hard disk drive A and the removable disk (F:) corresponding to the flash drive B), respectively.

Please keep referring to FIG. 2. Each of the selection fields F1-F3 has a selection icon. The user may click to select the selection icon in the selection field corresponding to an external device when the user needs to remove the external device. After the user determines and selects the external devices to be removed, the user may click a removal button 206, and the computer system may receive a removal signal corresponding to the removal button 206. When receiving the removal signal, the computer system may determine whether to perform a removal procedure on the corresponding external devices (the external hard disk drive A, the flash drive B or the smart phone C) according to whether each of the selection fields F1-F3 is selected. For example, if the user needs to remove the flash drive B and the smart phone C, the user may click and select the selection icons in the selection fields F2 and F3 and then click the removal button 206. When the computer system receives the removal signal corresponding to the removal button 206, the computer system may perform the removal procedure on the flash drive B and the smart phone C. On the other hand, since the user does not click and select the selection icon in the selection field F1, the computer system may not perform the removal procedure on the external hard disk drive A.

Please note that the list 204 further includes a select-all button 208, wherein the selection of the select-all button 208 is the same as the selections of all of the selection fields F1-F3. In other words, if the user needs to remove all external devices, the user may click and select the select-all button 208 and then click the removal button 206. The computer system then performs the removal procedure on all of the external devices. As a result, the user does not need to click the selection icons in all of the selection fields one by one when the user removes all external devices; instead, the user only needs to click the select-all button 208. This significantly reduces the time required for clicking operations and improves the convenience if there are a large number of external devices.

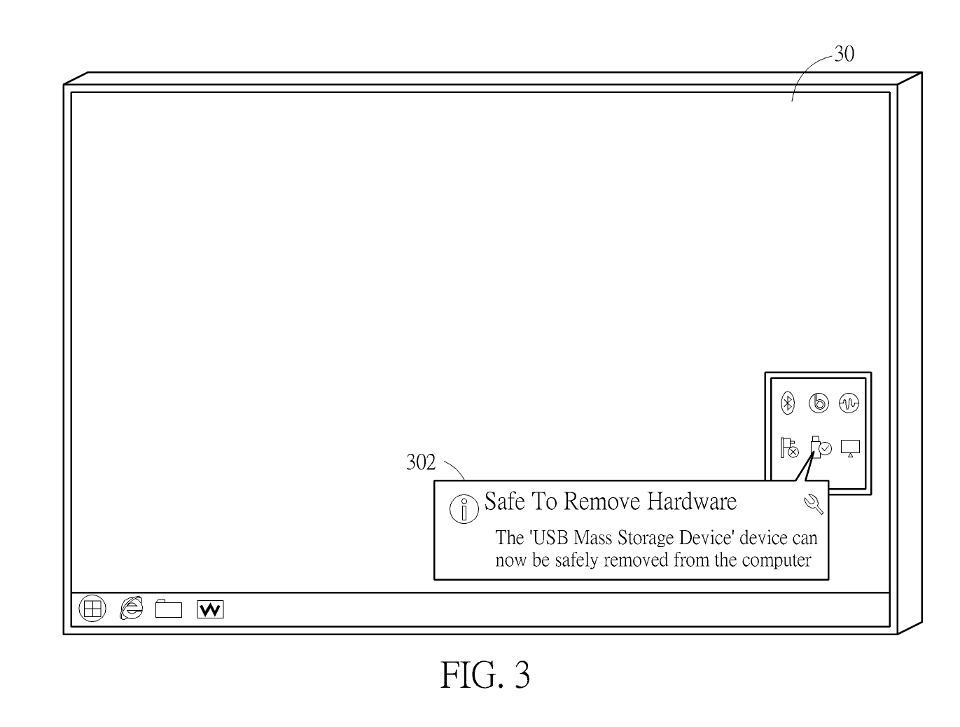

In general, an external device may be removable when it is idle. If the external device is in use or transmitting data, it cannot be successfully removed. Therefore, during the removal procedure, the computer system may first determine whether the external device is in use or transmitting data. When an external device is not in use or transmitting data, the computer system may be able to remove the external device, and the display device may display the information related to the successful removal of the external device. Please refer to FIG. 3, which is a schematic diagram of a display device 30 displaying a successful removal of the external device according to an embodiment of the present invention. As shown in FIG. 3, when the external device is removed successfully, the display device 30 may display a text box 302, which includes text such as “Safe To Remove Hardware” to indicate that the external device is successfully removed and the user may physically remove (e.g., pull out) the external device. In an embodiment, the text box 302 may include information related to the name and disk letter of the external device which is successfully removed, which is not limited herein.

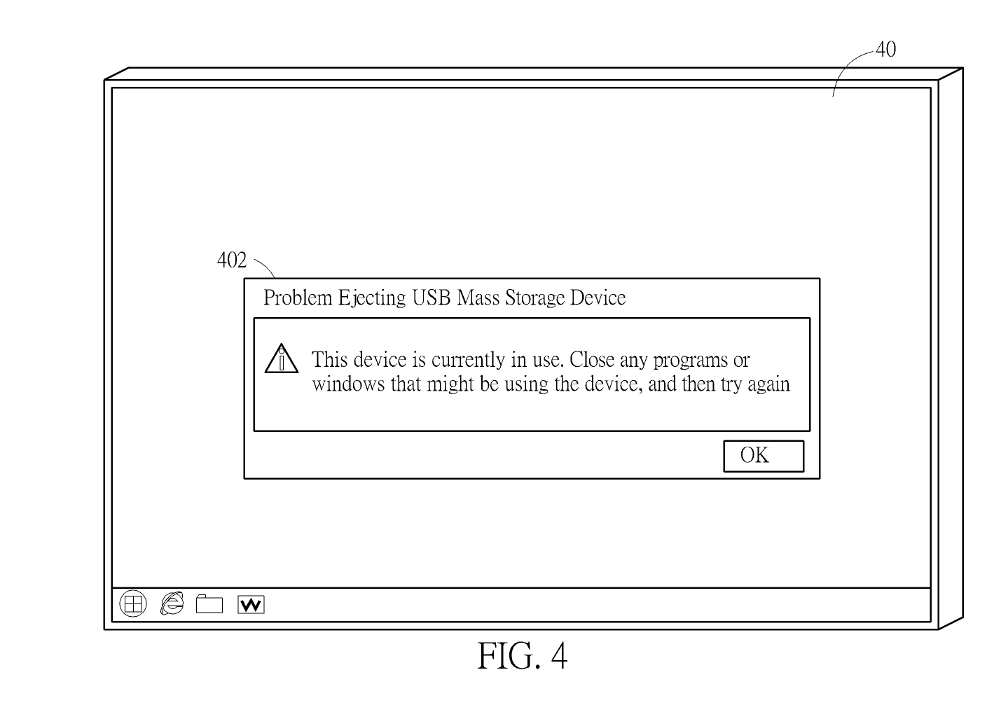

On the other hand, if an external device is in use or transmitting data, the computer system cannot remove the external device, and thereby displays the information related to the unsuccessful removal of the external device on the display device. Please refer to FIG. 4, which is a schematic diagram of a display device 40 displaying a failed removal of the external device according to an embodiment of the present invention. As shown in FIG. 4, when the external device fails to be removed, the display device 40 may display a text box 402, which includes text such as “This device is currently in use. Close any programs or window that might be using the device, and then try again.” to notify that the user should remove the external device after closing the program(s) related to the external device. In an embodiment, the text box 402 may include information related to the name and disk letter of the external device which fails to be removed, which is not limited herein.

In some embodiments, among the external devices selected to be removed by the user, there may be several external devices currently in use or transmitting data and several external devices successfully removed. Although the external devices currently in use or transmitting data cannot be removed, they do not affect the removal of other external devices. That is, the removal procedure of different external devices is simultaneously processed without affecting each other. In such a situation, the display device may simultaneously display information related to the successful removal of several external devices and information related to the failed removal of several external devices. In other words, the text box 302 shown in FIG. 3 and the text box 402 shown in FIG. 4 may simultaneously appear on the display device. For example, the user may simultaneously select to remove the flash drive B and the smart phone C, and the flash drive B may be successfully removed but the smart phone C cannot be removed since it is in use. In such a situation, the display device not only displays the information related to the successful removal of the flash drive B, but also displays the information related to the failed removal of the smart phone C.

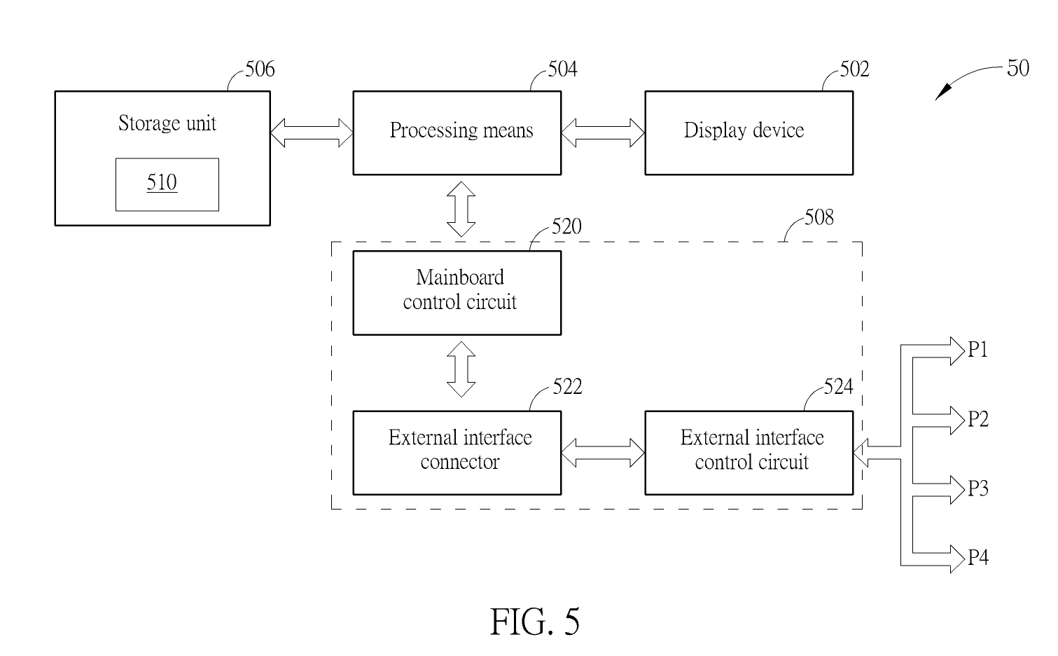

Please note that the removal procedure for each of the external devices is simultaneously processed according to the method of removing the external devices described in the present invention; hence, the signals related to the removal of external devices may be transmitted via a parallel interface. In an embodiment, the parallel interface may be realized via a circuit structure. Please refer to FIG. 5, which is a schematic diagram of a computer system 50 according to an embodiment of the present invention. As shown in FIG. 5, the computer system 50 includes a display device 502, a processing means 504, a storage unit 506 and a mainboard 508. Other components or modules such as a keyboard, mouse, microphone or power management device may be disposed arbitrarily according to system requirements, and are omitted in FIG. 5 since these components do not affect the illustration of the present embodiment. In detail, the display device 502 may include a screen for performing the display operations of the computer system 50, e.g., displaying the abovementioned information related to whether the external devices are successfully removed. The processing means 504 may be a central processing unit (CPU), microprocessor, micro controller unit (MCU) or other type of processing means. The storage unit 506 may be utilized for storing a program code 510 which instructs the processing means 504 to execute the removal operations for the external devices. The storage unit 506 may be any type of storage medium, such as a memory, a hard disk drive or a combination of different types of storage media.

Please keep referring to FIG. 5. The mainboard 508 includes a mainboard control circuit 520, an external interface connector 522, an external interface control circuit 524 and external device connection ports P1-P4. When the computer system 50 is connected to the external devices via a USB interface, the external device connection ports P1-P4 are USB ports. In such a situation, the external interface connector 522 may be a USB connector, and the external interface control circuit 524 may be a USB control circuit.

According to the data transmission protocol of the USB interface, data communication between the computer system and the external devices is always serially transmitted. Conventionally, the external interface connector 522 using the USB interface may directly be connected to the external device connection ports P1-P4, and serialize the signals from each of the external device connection ports P1-P4 to achieve serial transmission. In comparison, according to the present invention, since the removal of different external devices is performed simultaneously, the removal operations related to the external devices may apply parallel processing instead of serial processing. In such a situation, the external interface control circuit 524 may be deployed between the external interface connector 522 and the external device connection ports P1-P4. The external interface control circuit 524 may use multiple transmission interfaces to simultaneously process instructions for multiple external devices, in order to achieve the parallel operations.

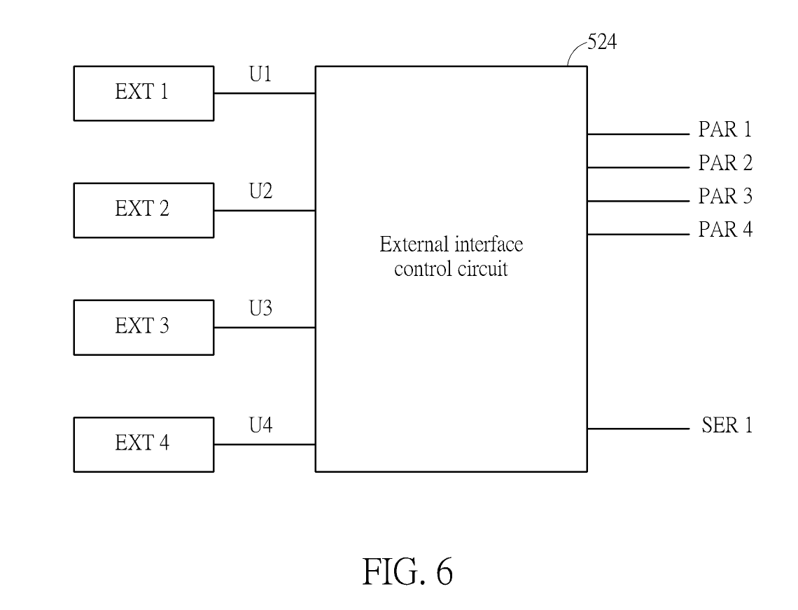

Take data transmission of the USB interface as an example. Please refer to FIG. 6, which is a schematic diagram of a USB control circuit 60 according to an embodiment of the present invention. The USB control circuit 60 may be an implementation of the external interface control circuit 524 shown in FIG. 5 performing a transmission via the USB interface. As shown in FIG. 6, the USB control circuit 60, which includes parallel detection interfaces PAR1-PAR4 and a serial data interface SER1, is connected to external devices EXT1-EXT4 via USB interfaces U1-U4 (which may be regarded as the external device connection ports P1-P4 shown in FIG. 5). The parallel detection interfaces PAR1-PAR4 are utilized for processing the connection and removal of the external devices EXT1-EXT4, and each of the parallel detection interfaces PAR1-PAR4 corresponds to each of the USB interfaces U1-U4, respectively. The serial data interface SER1 is utilized for transmitting the data of the external devices EXT1-EXT4. In other words, if the external devices EXT1-EXT4 need to perform data transmission, the data of the USB interfaces U1-U4 may be transmitted via the serial data interface SER1 since the data transmission protocol of the USB interface mainly utilizes serial transmission for data, where the serial transmission may achieve preferable transmission efficiency. On the other hand, if the external devices EXT1-EXT4 need to be removed by using the removal procedure, parallel processing may be applied since the external devices EXT1-EXT4 may be removed simultaneously. That is, the parallel detection interfaces PAR1-PAR4 may be utilized for the signals for detecting or removing the external devices EXT1-EXT4. As a result, the removal procedure of different external devices EXT1-EXT4 may be performed simultaneously.

In another embodiment, the parallel processed removal procedure may also be implemented via software; that is, programs for controlling multiple external devices to be removed simultaneously may be included in the program code 510, to instruct the processing means 504 to simultaneously process the removal procedures for multiple external devices.

Please note that the present invention may display the list on the display device. This allows a user to select the external devices desired to be removed from the list, in order to simultaneously remove multiple external devices in one removal operation. Those skilled in the art can make modifications and alternations accordingly. For example, the computer system of the present invention may be any type of computer system such as a desktop, laptop, tablet and netbook, which should not be limited herein. The computer system may also be any electronic device having an external interface such as a smartphone, personal digital assistant (PDA) and various video/audio players. As long as the electronic device can be connected to a plurality of external devices via the external interface, the method of simultaneously removing multiple external devices described in the present invention may be applied. In addition, the abovementioned display device displays the list and the information related to whether the external device is successfully removed on the screen, but in other embodiments, the display device may also display by other method, such as light and sound. Furthermore, the method of selecting the external devices performed by the user may not be limited to the click selection with a mouse, and the input of user selection may also be performed via a touch screen or other input facilities, which is not limited herein.

On the other hand, the standard of USB interface used in the present invention may be USB 2.0, USB 3.0 or other type of USB interface, which should not be limited herein. In addition, in the above embodiments, the USB interface is applied for the connection to the external devices, but in other embodiments, other types of input/output interface may also be applied, such as RS-232, peripheral component interconnect express (PCIe) or an evolution of the USB interface, which is not limited herein. Furthermore, the deployment of the selection fields and selection icons in the list 204 as shown in FIG. 2 is only one of various embodiments. Those skilled in the art may adjust the display method or location of the removal button 206, the selection fields F1-F3 and the selection icons in the list 204, or may modify the symbols of the selection icon for the user to make selection according to system requirements.

In addition to the select-all button 208, the list 204 may also include a deselect-all button, and the user may click the deselect-all button to deselect all of the external devices having been selected and then re-perform the selection. The external devices corresponding to different selection fields may be of the same model, the same type with different models or different types, and those skilled in the art may determine the numbers and names of the external devices accordingly. For example, the user may name each external device and allocate a disk letter according to the type or model of the external device, where the name or disk letter may be utilized for distinguishing each external device. Alternatively, if there are two external devices having the same model connected to the computer system, different numbers may be utilized to distinguish them, which is not limited herein. In addition, if an external device connected to the computer system is not in a disk form, the user may not allocate any disk letter to the external device, as the smart phone C shown in FIG. 2.

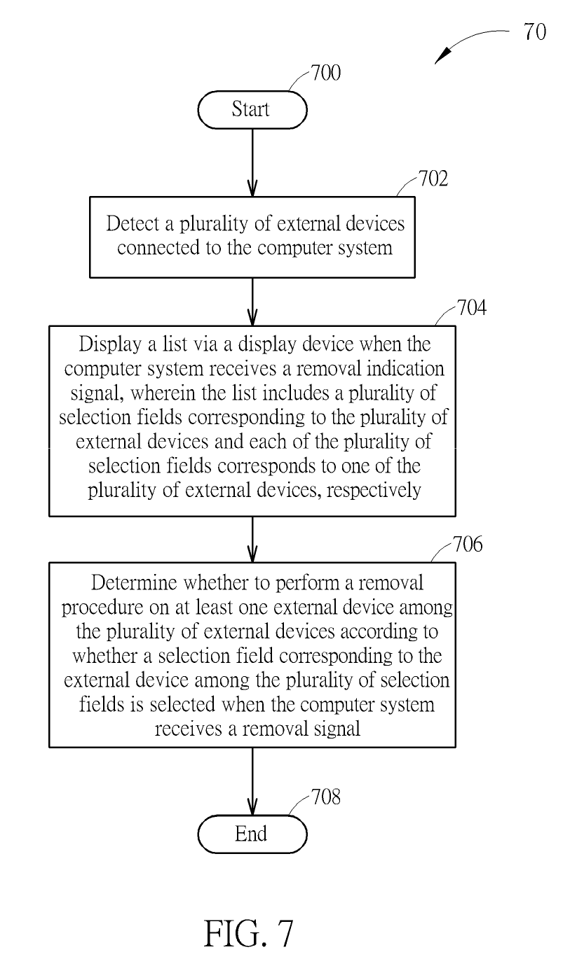

The abovementioned operations related to the program code 510 may be summarized into an external device removal process 70, as shown in FIG. 7. The external device removal process 70 includes the following steps:

Step 700: Start.

Step 702: Detect a plurality of external devices connected to the computer system.

Step 704: Display a list via a display device when the computer system receives a removal indication signal, wherein the list includes a plurality of selection fields corresponding to the plurality of external devices and each of the plurality of selection fields corresponds to one of the plurality of external devices, respectively.

Step 706: Determine whether to perform a removal procedure on at least one external device among the plurality of external devices according to whether a selection field corresponding to the external device among the plurality of selection fields is selected when the computer system receives a removal signal.

Step 708: End.

The detailed operations and alternations of the external device removal process 70 can be referred to the above description, and will not be narrated herein.

Please note that in the context of this disclosure, a non-transitory computer-readable medium stores programs for use by or in connection with an instruction execution system, apparatus, or device. In this regard, one example, among others, is a non-transitory computer-readable medium embodying a program executable in a computing device such as the computer system 50 shown in FIG. 5. In accordance with such examples, the program comprises code for detecting a plurality of external devices connected to the computer system; code for displaying a list via a display device when the computer system receives a removal indication signal, wherein the list comprises a plurality of selection fields corresponding to the plurality of external devices and each of the plurality of selection fields corresponds to one of the plurality of external devices, respectively; and code for determining whether to perform a removal procedure on at least one external device among the plurality of external devices according to whether a selection field corresponding to the external device among the plurality of selection fields is selected when the computer system receives a removal signal. Other alternations related to the abovementioned methods may also be compiled to the program executable in the computing device.

The abovementioned computer-readable medium can be any medium that can contain, store, or maintain the program described herein for use by or in connection with the instruction execution system. The computer-readable medium may comprise any one of physical media such as, for example, magnetic, optical, or semiconductor media. More specific examples of a suitable computer-readable medium may include, but not limited to, a magnetic tape, a magnetic floppy diskette, a magnetic hard drive, a memory card, a solid-state drive, a USB flash drive, an optical disc, a random access memory (RAM) including a static random access memory (SRAM), a dynamic random access memory (DRAM) and a magnetic random access memory (MRAM), a read-only memory (ROM) including a programmable read-only memory (PROM), an erasable programmable read-only memory (EPROM), an electrically erasable programmable read-only memory (EEPROM), or other type of memory device.

In the prior art, if a user needs to remove external devices, the user can only remove one external device at a time. When the computer system is connected to multiple external devices, the procedure of removing an external device should be repeated, which requires a lot of time for removing all of the external devices. In comparison, the method of removing external devices and the computer system of the present invention may display a list for a user to make selection and the user may select the external devices desired to be removed via a plurality of selection fields corresponding to a plurality of external devices in the list. This allows the user to simultaneously remove multiple external devices in one removal operation. Through the embodiments of the present invention, the time required for removing the external devices can be reduced significantly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of removing external devices for a computer system, comprising:
displaying a list via a display device when the computer system receives a removal indication signal, wherein the list comprises a plurality of selection fields corresponding to a plurality of external devices and each of the plurality of selection fields corresponds to one of the plurality of external devices, respectively; and
determining whether to perform a removal procedure on at least one external device among the plurality of external devices according to whether a selection field corresponding to the external device among the plurality of selection fields is selected when the computer system receives a removal signal.

2. The method of claim 1, further comprising:
performing the removal procedure on a first external device among the plurality of external devices when a first selection field corresponding to the first external device among the plurality of selection fields is selected; and
not performing the removal procedure on a second external device among the plurality of external devices when a second selection field corresponding to the second external device among the plurality of selection fields is not selected.

3. The method of claim 1, wherein the removal procedure comprises:
determining whether an external device of the plurality of selection fields is in use or transmitting data;
removing the external device and displaying information related to a successful removal of the external device on the display device when the external device is not in use or transmitting data; and
displaying information related to an unsuccessful removal of the external device on the display device when the external device is in use or transmitting data.

4. The method of claim 1, wherein the list further comprises a select-all button, and a selection of the select-all button is the same as selections of all of the plurality of selection fields.

5. The method of claim 1, wherein at least one of the plurality of external devices is connected to the computer system via a universal serial bus (USB) interface.

6. The method of claim 1, further comprising:
simultaneously processing the removal procedure of the plurality of external devices.

7. The method of claim 1, further comprising:
detecting the plurality of external devices connected to the computer system.

8. A computer system, comprising:
a display device;
a mainboard, comprising a plurality of external device connection ports;
a processing means; and
a storage unit, for storing a program code instructing the processing means to execute the following steps in order to remove external devices:
displaying a list via the display device when the computer system receives a removal indication signal, wherein the list comprises a plurality of selection fields corresponding to a plurality of external devices and each of the plurality of selection fields corresponds to one of the plurality of external devices, respectively; and
determining whether to perform a removal procedure on at least one external device among the plurality of external devices according to whether a selection field corresponding to the external device among the plurality of selection fields is selected when the computer system receives a removal signal.

9. The computer system of claim 8, wherein the processing means performs the removal procedure on a first external device among the plurality of external devices when a first selection field corresponding to the first external device among the plurality of selection fields is selected, and does not perform the removal procedure on a second external device among the plurality of external devices when a second selection field corresponding to the second external device among the plurality of selection fields is not selected.

10. The computer system of claim 8, wherein the removal procedure comprises:
determining whether an external device of the plurality of selection fields is in use or transmitting data;
removing the external device and displaying information related to a successful removal of the external device on the display device when the external device is not in use or transmitting data; and
displaying information related to an unsuccessful removal of the external device on the display device when the external device is in use or transmitting data.

11. The computer system of claim 8, wherein the list further comprises a select-all button, and a selection of the select-all button is the same as selections of all of the plurality of selection fields.

12. The computer system of claim 8, wherein at least one of the plurality of external devices is connected to the computer system via a universal serial bus (USB) interface.

13. The computer system of claim 8, wherein the program code further instructs the processing means to execute the following step in order to remove external devices:
simultaneously processing the removal procedure of the plurality of external devices.

14. The computer system of claim 8, wherein the mainboard comprises:
an external interface control circuit, for controlling operations of the plurality of external devices, the external interface control circuit comprising:
a plurality of parallel detection interfaces, for processing connections and removals of the plurality of external devices, wherein each of the plurality of parallel detection interfaces corresponds to each of the plurality of external device connection ports, respectively; and
a serial data interface, for transmitting data of the plurality of external devices.

15. The computer system of claim 8, wherein the program code further instructs the processing means to execute the following step:
detecting the plurality of external devices connected to the plurality of external device connection ports.

16. A non-transitory computer-readable medium having a program code executable in a computer system, the program code comprising:
code for displaying a list via a display device when the computer system receives a removal indication signal, wherein the list comprises a plurality of selection fields corresponding to a plurality of external devices and each of the plurality of selection fields corresponds to one of the plurality of external devices, respectively; and
code for determining whether to perform a removal procedure on at least one external device among the plurality of external devices according to whether a selection field corresponding to the external device among the plurality of selection fields is selected when the computer system receives a removal signal.

17. The non-transitory computer-readable medium of claim 16, wherein the program code further comprises:
code for performing the removal procedure on a first external device among the plurality of external devices when a first selection field corresponding to the first external device among the plurality of selection fields is selected; and
code for not performing the removal procedure on a second external device among the plurality of external devices when a second selection field corresponding to the second external device among the plurality of selection fields is not selected.

18. The non-transitory computer-readable medium of claim 16, wherein the removal procedure comprises:
determining whether an external device of the plurality of selection fields is in use or transmitting data;
removing the external device and displaying information related to a successful removal of the external device on the display device when the external device is not in use or transmitting data; and
displaying information related to an unsuccessful removal of the external device on the display device when the external device is in use or transmitting data.

19. The non-transitory computer-readable medium of claim 16, wherein the list further comprises a select-all button, and a selection of the select-all button is the same as selections of all of the plurality of selection fields.

20. The non-transitory computer-readable medium of claim 16, wherein at least one of the plurality of external devices is connected to the computer system via a universal serial bus (USB) interface.

21. The non-transitory computer-readable medium of claim 16, wherein the program code further comprises:
code for simultaneously processing the removal procedure of the plurality of external devices.

22. The non-transitory computer-readable medium of claim 16, wherein the program code further comprises:
code for detecting the plurality of external devices connected to the computer system.
